(19) United States
(12) Patent Application Publication
(10) Pub. No.: US 2019/0131081 A1
(43) Pub. Date: May 2, 2019

(54) RETROFIT SWITCH

(71) Applicant: LEEDARSON AMERICA INC., Smyma, GA (US)

(72) Inventor: Yongchuan Li, Smyrna, GA (US)

(21) Appl. No.: 15/797,935

(22) Filed: Oct. 30, 2017

(51) Int. Cl. H01H 9/02; H01H 9/54; H01H 9/16

(52) U.S. Cl. CPC H01H 9/0271; H01H 9/16; H01H 9/54

(57) ABSTRACT

A retrofit switch apparatus is designed to be attached to a traditional switch device. The traditional switch device has a traditional switch mounted on a traditional switch cover surface of the traditional switch device used for accepting a first user manual operation to control a target device. The retrofit switch apparatus has an attaching device, a retrofit housing, a mechanical switch and a wireless controller. The attaching device is used for attaching to the traditional switch cover surface. The retrofit housing provides a containing space for covering the traditional switch. The mechanical switch receives a second user manual operation the same as the first user manual operation.

### FIELD OF INVENTION

The present invention relates to a retrofit switch and more particularly related to a retrofit switch capable of wirelessly controlling a target device.

### BACKGROUND

IoT (Internet of Things) technologies are developed rapidly and various devices are invented for making human life more convenient. For example, wireless speakers, door locks, lights are easily controlled by a mobile phone via Bluetooth today.

Meanwhile, there are many traditional devices like lamp or downlight installed in a conventional house. It would be very helpful if certain innovative modifications are provided to turn these traditional devices into a controllable IoT network device.

### SUMMARY OF INVENTION

According to a first embodiment of the invention, a retrofit switch apparatus is provided to be attached to a traditional switch device. The traditional switch device is fixed to an environment surface like a wall. The traditional switch device may also be fixed to other surface like a table, a cabin, car housing and any other devices that traditionally has traditional switch. Examples of such traditional switch includes but not limited to in-wall switches like On/Off Switches, keypads, digital switches, occupancy sensing switches, push-button switches, dimming switches such as rotary dimmers, slide dimmers, digital dimmers, and step dimmers.

Such traditional switch device has a traditional switch mounted on a traditional switch cover surface for accepting a first user manual operation to control a target device. The target device may be a light, an air conditioner, a fan or any other electrical device connected to the traditional switch device with an electrical wire. In some embodiments, such electrical wire is embedded behind a wall.

In the embodiment, the retrofit switch apparatus has an attaching device, a retrofit housing, a mechanical switch, and a wireless controller.

The attaching device is attached to the traditional switch cover surface, like a panel with conventional appearance.

The retrofit housing is connected to the attaching device for providing a containing space for covering the traditional switch so as to keep the traditional switch remaining a predetermined operation status when the attaching device being attached to the traditional switch cover surface. For example, if the traditional switch is a ON/OFF toggle switch, the traditional switch is hidden in the containing space so that a previous status like ON would be remained because a user does not see or touch the traditional switch directly in such situation.

One or more mechanical switches are connected to the retrofit housing and are exposed for receiving a second user manual operation. The second user manual operation may be the same as the first user manual operation. In other words, the original function of the traditional switch is now replaced and supported by the one or more mechanical switches of the retrofit switch apparatus.

The wireless controller is connected to the mechanical switch for controlling the target device via a wireless control signal in response to the second user manual operation on the mechanical switch.

In some embodiments, the mechanical switch has a similar mechanical appearance as the traditional switch of the traditional switch device. In such design, users may feel more comfortable because there is no need to learn a new way to operate the target device.

In some embodiments, the attaching device may have a surface part, a mounting part, and a connector part. The surface part is fixed on the traditional switch cover surface. For example, the surface part may be a bracket using glue or screws to fix on the traditional switch cover surface. On the other hand, the mounting part is fixed to the mechanical switch, which means being connected to the mechanical switch portion directly or indirectly. Overall, the mounting part and the surface part have a detachable connection via the connector part. In other words, the mounting part and the surface part may be separated. When needed, the mounting part and the surface part may be assembled together again via the connector part. The connector party may have two corresponding units respectively disposed on the surface part and the mounting part. Other structure that may connect two parts may also be used as the connector part mentioned here.

In some embodiments, the connector part may include magnet components and using magnetic force to keep the mounting part and the surface together while remaining possibility to separate the mounting part and the surface part with certain force applying thereon. It is useful if we can keep the traditional switch to remained turning on electrical power to the target device to keep the control circuit in the target device function normally, but it is also useful if we can keep the user an option to temporarily operate the traditional switch. For example, if the user wants to replace a bulb in the target device and the power is kept turning on because the traditional switch is hidden and kept that mode, it may cause certain undesired danger. In addition, there is chance that the retrofit switch apparatus may not function normally. When this happens, it is very helpful to allow the user to use original traditional switch to get things done, instead of the need to find a screw driver just to expose the traditional switch to operate.

In some other embodiments, the attaching device may include a rotatable axis for providing a first mode and a second mode. The traditional switch is covered by the retrofit housing and kept untouchable from a user in the first mode. A part of the retrofit housing is rotated with respect to the traditional switch along the rotatable axis to expose the traditional switch to the user in the second mode for the user to operate the traditional switch. In other words, the user may uncover and use the traditional switch just like opening a book along the rotating the rotatable axis. The rotatable axis may be regarded as an option to implement the connector part as mentioned above.

In addition, the retrofit switch apparatus may include a battery box. The battery box is used for holding a battery for supplying power to the wireless controller. The battery box is exposed to the user in the second mode so that the user may replace a battery in the battery box easily.

In some embodiments, the attaching device may include a sucker unit using air pressure to attach the retrofit housing upon the traditional switch. Such sucker unit may be made of elastic plastic with an opening and an air space. Users may press the opening to the traditional switch surface cover to press air out of the air space so that the opening have a sucking force to keep the retrofit switch apparatus to the traditional switch device to be fixed together. Such mechanism is helpful when the traditional switch surface is smooth and such method provides a convenient and easy installation of the retrofit switch apparatus. More than one sucker units may be used to enhance attachment reliability.

In some embodiments, the attaching device may include an adhesive tape using glue to attach the retrofit housing upon the traditional switch. More than one ways may also be applied at the same time.

For some traditional switches, they have corresponding display to show certain status. In such case, a display window may be disposed on the retrofit housing. Specifically, the traditional switch device has a display showing a status of the target device, and the display window shows the status. The display window may be an opening to expose the display of the traditional switch device. Alternatively, the display window may also be an electronic display driven by the wireless controller to shows the status.

In some embodiments, the wireless controller may also drive a visual indicator like a display or LED indicators to show working status to the user. For example, the indicator may show whether the wireless controller is successfully communicating and controlling the target device, or the battery is in low status.

In some embodiments, the visual indicator changes appearance, like showing different colors or different lighting patterns, to give a feedback to a user when the user is operating the retrofit switch apparatus. This is helpful to be a more effective and friendly user interface.

In some embodiments, the wireless controller may use an audio indicator, like a speaker, for generating sound in response to the second user manual operation. For example, certain sound effects may be helpful to assist the user to operate the retrofit switch apparatus and get better user experience.

In some embodiments, the traditional switch may be an on/off toggle switch, a push button switch, a rotary dimmer or a step dimmer. Other types of traditional switches may be implemented when needed. The mechanic switch of the retrofit switch apparatus may have the same shape as the associated traditional switch or have similar or different shapes as the associated traditional switch once the mechanical switch is capable of performing the same or more function compared with the associated traditional switch.

In some embodiments, the wireless controller may be configured to control a plurality of devices in addition to the target device. For example, we may place a retrofit switch apparatus above on a traditional switch that only controls a target device. With the design as mentioned, the retrofit switch apparatus replaces the function of the traditional switch. The retrofit switch apparatus may not need to stop there and may be further configured to control more devices in addition to the target device. A different predetermined operation, e.g. continuous two clicks, may be used to instruct the retrofit switch to control a second target device. If there is a display provided, more complicated operations may be achieved effectively. In addition, the retrofit switch device may be configured by receiving commands from a connected mobile phone or a digital television.

In some embodiments, the retrofit switch apparatus is not electrically connected to the traditional switch device. But, in some other embodiments, the retrofit switch apparatus may also be configured to receive power supply from the traditional switch device. In such case, it would be easier for the user because the user does not need to worry to recharge or replace a battery for the retrofit switch apparatus.

The retrofit housing may have any desired shapes. For example, the retrofit housing may have shape of a square box, a circular disk or any shapes.

### BRIEF DESCRIPTION OF DRAWINGS

FIG. 1 illustrates attaching a retrofit switch apparatus to a traditional switch device.

FIG. 2 illustrates relation between a switch and a target device.

FIG. 3 illustrates a cross section view of a retrofit switch apparatus.

FIG. 4A and FIG. 4B illustrates use scenarios of a traditional switch device and a retrofit switch apparatus.

FIG. 5 illustrates a retrofit switch apparatus rotated with respect to a traditional switch device.

### DETAILED DESCRIPTION

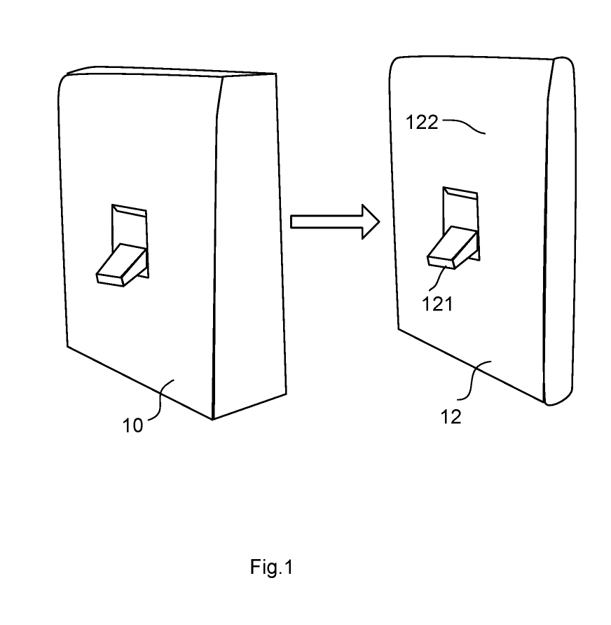

Please refer to FIG. 1, which illustrates a retrofit switch apparatus be attached to a traditional switch device 12. The traditional switch device 12 is fixed to an environment surface 13 like a wall. The traditional switch device 12 may also be fixed to other surface like a table, a cabin, car housing and any other devices that traditionally has traditional switch. Examples of such traditional switch includes but not limited to in-wall switches like On/Off Switches, keypads, digital switches, occupancy sensing switches, push-button switches, dimming switches such as rotary dimmers, slide dimmers, digital dimmers, and step dimmers.

Such traditional switch device 12 has a traditional switch 121 mounted on a traditional switch cover surface 122 for accepting a first user manual operation to control a target device.

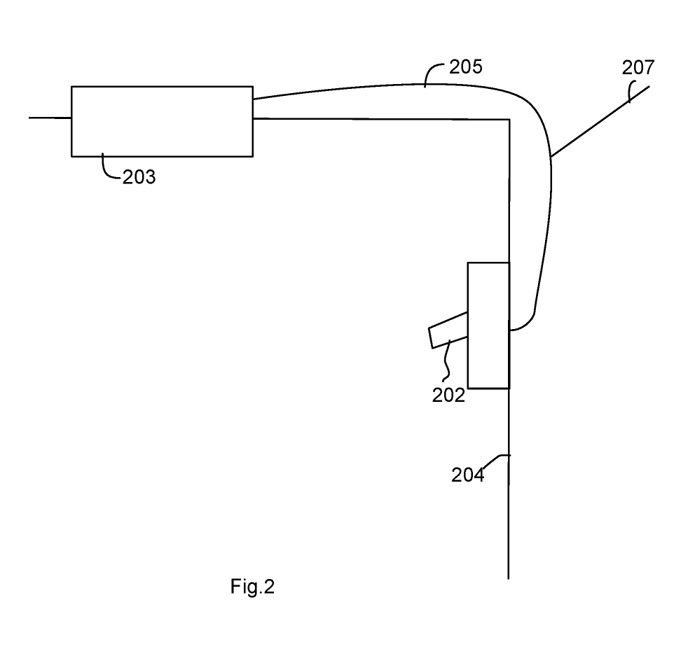

Please refer to FIG. 2, which illustrates how a traditional switch device 202 is used for controlling a target device 203. In this example, the target device 203 is a downlight connected to the traditional switch device 202 via an electrical wire 205 hidden behind a wall 204. The electrical wire 205 is further electrically connected to an power source 207. The traditional switch device 202 has a traditional switch to open or close a electrical loop of the target device 203 to the power source 207 to turn on or turn off the target device 203.

In other words, the target device may be a light, an air conditioner, a fan or any other electrical device connected to the traditional switch device with an electrical wire. In some embodiments, such electrical wire is embedded behind a wall.

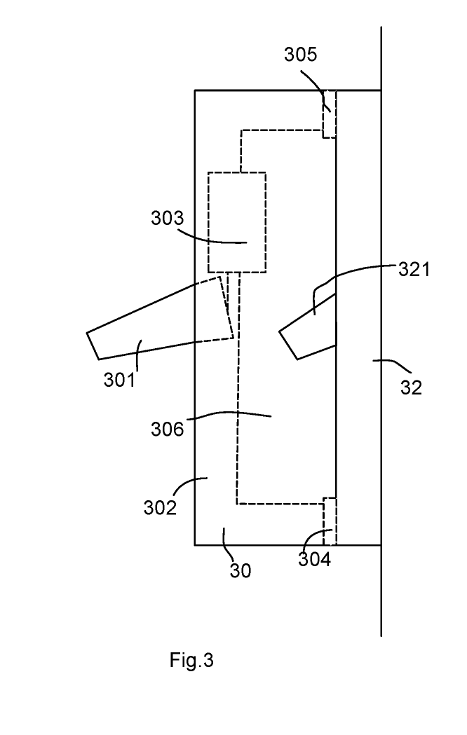

Please refer to FIG. 3, which illustrate a cross sectional view of the embodiment. In the embodiment, the retrofit switch apparatus 30 has a mechanical switch 301, a retrofit housing 302 and two attaching devices 304, 305, and a wireless controller 303. The retrofit housing 302 defines a containing space 306 to contain a traditional switch 321 of a traditional switch device 32. The attaching devices 304, 305 ensure the retrofit switch apparatus 30 to attach to the traditional switch device 32. By hiding and covering the traditional switch 321 in the containing space 306, users may not operate the traditional switch 321 and thus the traditional switch 321 is kept the operation mode when the retrofit switch apparatus 30 is attached to the traditional switch device 32.

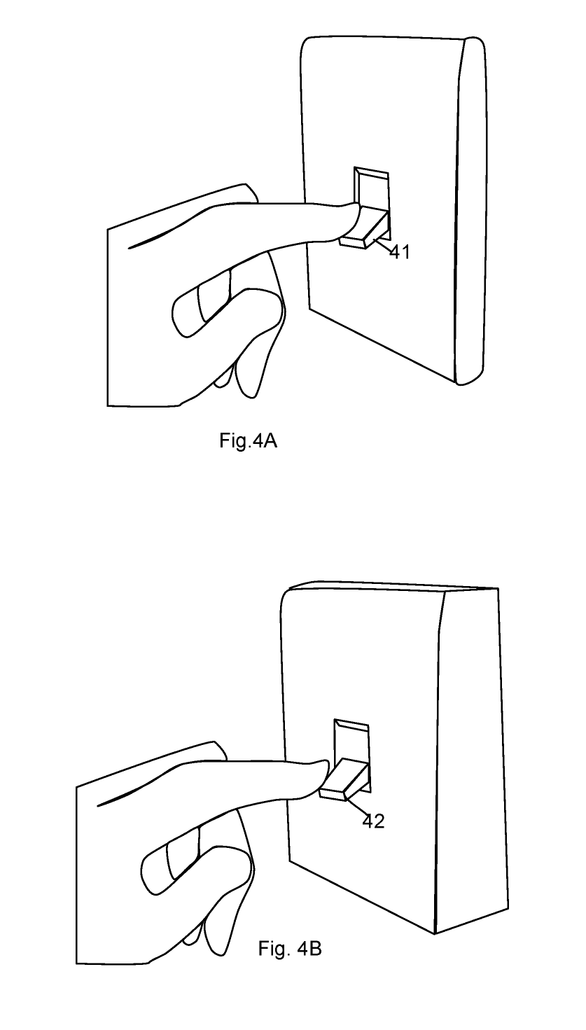

Please refer to FIG. 4A and FIG. 4B. FIG. 4A illustrates the original operation of a user to a traditional switch 41. FIG. 4B illustrates new operation on a mechanical switch 42 of a retrofit switch apparatus when the retrofit switch apparatus is mounted on a traditional switch device. In the illustration, it can be seen that even the user turns on or turns off the mechanical switch 42, the traditional switch 41 inside the retrofit switch apparatus is not effected.

In general, the attaching device is attached to the traditional switch cover surface, like a panel with conventional appearance.

The retrofit housing is connected to the attaching device for providing a containing space for covering the traditional switch so as to keep the traditional switch remaining a predetermined operation status when the attaching device being attached to the traditional switch cover surface. For example, if the traditional switch is a ON/OFF toggle switch, the traditional switch is hidden in the containing space so that a previous status like ON would be remained because a user does not see or touch the traditional switch directly in such situation.

One or more mechanical switches are connected to the retrofit housing and are exposed for receiving a second user manual operation. The second user manual operation may be the same as the first user manual operation. In other words, the original function of the traditional switch is now replaced and supported by the one or more mechanical switches of the retrofit switch apparatus.

The wireless controller is connected to the mechanical switch for controlling the target device via a wireless control signal in response to the second user manual operation on the mechanical switch.

In some embodiments, the mechanical switch has a similar mechanical appearance as the traditional switch of the traditional switch device. In such design, users may feel more comfortable because there is no need to learn a new way to operate the target device.

In some embodiments, the attaching device may have a surface part, a mounting part, and a connector part. The surface part is fixed on the traditional switch cover surface. For example, the surface part may be a bracket using glue or screws to fix on the traditional switch cover surface. On the other hand, the mounting part is fixed to the mechanical switch, which means being connected to the mechanical switch portion directly or indirectly. Overall, the mounting part and the surface part have a detachable connection via the connector part. In other words, the mounting part and the surface part may be separated. When needed, the mounting part and the surface part may be assembled together again via the connector part. The connector party may have two corresponding units respectively disposed on the surface part and the mounting part. Other structure that may connect two parts may also be used as the connector part mentioned here.

In some embodiments, the connector part may include magnet components and using magnetic force to keep the mounting part and the surface together while remaining possibility to separate the mounting part and the surface part with certain force applying thereon. It is useful if we can keep the traditional switch to remained turning on electrical power to the target device to keep the control circuit in the target device function normally, but it is also useful if we can keep the user an option to temporarily operate the traditional switch. For example, if the user wants to replace a bulb in the target device and the power is kept turning on because the traditional switch is hidden and kept that mode, it may cause certain undesired danger. In addition, there is chance that the retrofit switch apparatus may not function normally. When this happens, it is very helpful to allow the user to use original traditional switch to get things done, instead of the need to find a screw driver just to expose the traditional switch to operate.

In some other embodiments, the attaching device may include a rotatable axis, which may be logically or physically, for providing a first mode and a second mode. The traditional switch is covered by the retrofit housing and kept untouchable from a user in the first mode. A part of the retrofit housing is rotated with respect to the traditional switch along the rotatable axis to expose the traditional switch to the user in the second mode for the user to operate the traditional switch. In other words, the user may uncover and use the traditional switch just like opening a book along the rotating the rotatable axis. The rotatable axis may be regarded as an option to implement the connector part as mentioned above.

In addition, the retrofit switch apparatus may include a battery box. The battery box is used for holding a battery for supplying power to the wireless controller. The battery box is exposed to the user in the second mode so that the user may replace a battery in the battery box easily.

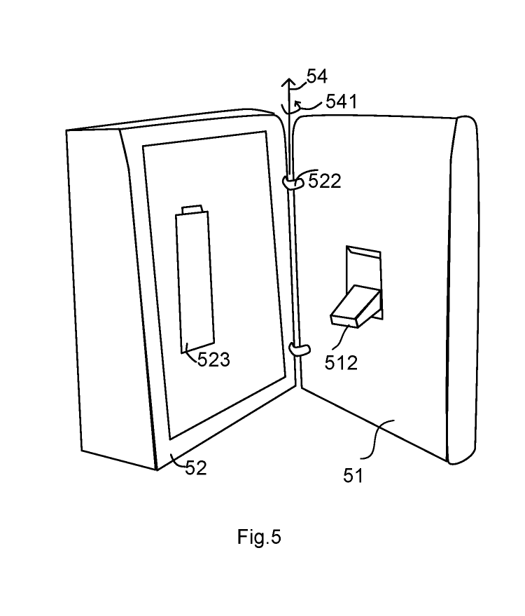

Please refer to FIG. 5, which illustrates a diagram in which a retrofit switch apparatus 52 is rotated with respect to a traditional switch device 51. The retrofit switch 52 has an attaching device 522 that defines a rotating axis 54. When the retrofit switch 52 is rotated with respect to the traditional switch apparatus 51 along the rotation direction 541, the traditional switch 512 may be exposed to be used again. In addition, a battery box of the retrofit switch apparatus 52 may be exposed and user may replace a battery 523 to power the wireless controller of the retrofit switch apparatus 52.

In some embodiments, the attaching device may include a sucker unit using air pressure to attach the retrofit housing upon the traditional switch. Such sucker unit may be made of elastic plastic with an opening and an air space. Users may press the opening to the traditional switch surface cover to press air out of the air space so that the opening have a sucking force to keep the retrofit switch apparatus to the traditional switch device to be fixed together. Such mechanism is helpful when the traditional switch surface is smooth and such method provides a convenient and easy installation of the retrofit switch apparatus. More than one sucker units may be used to enhance attachment reliability.

In some embodiments, the attaching device may include an adhesive tape using glue to attach the retrofit housing upon the traditional switch. More than one ways may also be applied at the same time.

For some traditional switches, they have corresponding display to show certain status. In such case, a display window may be disposed on the retrofit housing. Specifically, the traditional switch device has a display showing a status of the target device, and the display window shows the status. The display window may be an opening to expose the display of the traditional switch device. Alternatively, the display window may also be an electronic display driven by the wireless controller to shows the status.

In some embodiments, the wireless controller may also drive a visual indicator like a display or LED indicators to show working status to the user. For example, the indicator may show whether the wireless controller is successfully communicating and controlling the target device, or the battery is in low status.

In some embodiments, the visual indicator changes appearance, like showing different colors or different lighting patterns, to give a feedback to a user when the user is operating the retrofit switch apparatus. This is helpful to be a more effective and friendly user interface.

In some embodiments, the wireless controller may use an audio indicator, like a speaker, for generating sound in response to the second user manual operation. For example, certain sound effects may be helpful to assist the user to operate the retrofit switch apparatus and get better user experience.

In some embodiments, the traditional switch may be an on/off toggle switch, a push button switch, a rotary dimmer or a step dimmer. Other types of traditional switches may be implemented when needed. The mechanic switch of the retrofit switch apparatus may have the same shape as the associated traditional switch or have similar or different shapes as the associated traditional switch once the mechanical switch is capable of performing the same or more function compared with the associated traditional switch.

In some embodiments, the wireless controller may be configured to control a plurality of devices in addition to the target device. For example, we may place a retrofit switch apparatus above on a traditional switch that only controls a target device. With the design as mentioned, the retrofit switch apparatus replaces the function of the traditional switch. The retrofit switch apparatus may not need to stop there and may be further configured to control more devices in addition to the target device. A different predetermined operation, e.g. continuous two clicks, may be used to instruct the retrofit switch to control a second target device. If there is a display provided, more complicated operations may be achieved effectively. In addition, the retrofit switch device may be configured by receiving commands from a connected mobile phone or a digital television.

In some embodiments, the retrofit switch apparatus is not electrically connected to the traditional switch device. But, in some other embodiments, the retrofit switch apparatus may also be configured to receive power supply from the traditional switch device. In such case, it would be easier for the user because the user does not need to worry to recharge or replace a battery for the retrofit switch apparatus.

It is to be understood that the forms of the invention shown are preferred embodiments thereof and that various changes and modifications may be made therein without departing from the spirit of the invention or scope as defined in the following claims.

1. A retrofit switch apparatus for being attached to a traditional switch device, the traditional switch device being fixed to an environment surface and having a traditional switch mounted on a traditional switch cover surface of the traditional switch device used for accepting a first user manual operation to control a target device connected to the traditional switch device with an electrical wire, the retrofit switch apparatus comprising:
an attaching device for attaching to the traditional switch cover surface;
a retrofit housing connected to the attaching device for providing a containing space for covering the traditional switch so as to keep the traditional switch remaining a predetermined operation status when the attaching device being attached to the traditional switch cover surface;
a mechanical switch connected to the retrofit housing exposed for receiving a second user manual operation, wherein the second user manual operation is the same as the first user manual operation; and
a wireless controller connected to the mechanical switch for controlling the target device via a wireless control signal in response to the second user manual operation on the mechanical switch.

2. The retrofit switch apparatus of claim 1, wherein the mechanical switch has a similar mechanical appearance as the traditional switch of the traditional switch device.

3. The retrofit switch apparatus of claim 1, wherein the attaching device having a surface part, a mounting part, and a connector part, the surface part is fixed on the traditional switch cover surface, the mounting part fixed to the mechanical switch, and the mounting part and the surface part have a detachable connection via the connector part.

4. The retrofit switch apparatus of claim 3, wherein the connector part comprises magnet component for performing the detachable connection.

5. The retrofit switch apparatus of claim 1, wherein the attaching device comprises a rotatable axis for providing a first mode and a second mode, the traditional switch is covered by the retrofit housing and kept untouchable from a user in the first mode, and a part of the retrofit housing is rotated with respect to the traditional switch along the rotatable axis to expose the traditional switch to the user in the second mode for the user to operate the traditional switch.

6. The retrofit switch apparatus of claim 5, further comprising a battery box exposed to the user in the second mode for the user to replace a battery in the battery box.

7. The retrofit switch apparatus of claim 1, wherein the attaching device comprises a sucker unit using air pressure to attach the retrofit housing upon the traditional switch.

8. The retrofit switch apparatus of claim 1, wherein the attaching device comprising an adhesive tape using glue to attach the retrofit housing upon the traditional switch.

9. The retrofit switch apparatus of claim 1, further comprising a display window on the retrofit housing, wherein the traditional switch device has a display showing a status of the target device, the display window showing the status.

10. The retrofit switch apparatus of claim 9, wherein the display window is driven by the wireless controller to shows the status.

11. The retrofit switch apparatus of claim 9, wherein the display window is an opening showing the status of the traditional switch device to a user.

12. The retrofit switch apparatus of claim 1, wherein the wireless controller has a visual indicator showing a working status to a user.

13. The retrofit switch apparatus of claim 12, wherein the
visual indicator changes appearance in response to the second user manual operation.

14. The retrofit switch apparatus of claim 1, wherein the wireless controller has an audio indicator for generating sound in response to the second user manual operation.

15. The retrofit switch apparatus of claim 1, wherein the traditional switch is an on/off toggle switch.

16. The retrofit switch apparatus of claim 1, wherein the traditional switch is a push button switch.

17. The retrofit switch apparatus of claim 1, wherein the traditional switch is a rotary dimmer.

18. The retrofit switch apparatus of claim 1, wherein the traditional switch is a step dimmer.

19. The retrofit switch apparatus of claim 1, wherein the wireless controller controls a plurality of devices including the target device.

20. The retrofit switch apparatus of claim 1, wherein the wireless controller receives electrical power from the traditional switch device.
